(19) United States
(12) Patent Application Publication
(10) Pub. No.: US 2008/0183954 A1
(43) Pub. Date: Jul. 31, 2008

(54) APPARATUS FOR AND METHOD OF CONTROLLING EMBEDDED NAND FLASH MEMORY

(76) Inventors: Seung-won LEE, Seongnam-si (KR); Byeong-hoon Lee, Seoul (KR); Ki-hong Kim, Suwon-si (KR); Sun-kwon Kim, Suwon-si (KR)

Correspondence Address: F. CHAU & ASSOCIATES, LLC, 130 WOODBURY ROAD, WOODBURY, NY, 11797, US

(21) Appl. No.: 12/016,680

(22) Filed: Jan. 18, 2008

(30) Foreign Application Priority Data
Jan. 26, 2007 (KR) 10-2007-0008612

(51) Int. Cl. G06F 12/02

(52) U.S. Cl. 711/103; 711/E12.008

(57) ABSTRACT

An apparatus and method for controlling an embedded NAND flash memory. The apparatus includes a code memory storing code information for controlling an access to a NAND flash memory. A register stores code information corresponding to a command to be executed by the NAND flash memory. A central processing unit (CPU) reads the code information corresponding to the command to be executed by the NAND flash memory from the code memory and stores the read code information in the register. A hard-wired logic circuit performs the NAND flash memory access according to the code information stored in the register.

### CROSS-REFERENCE TO RELATED PATENT APPLICATION

This application claims priority to Korean Patent Application No. 10-2007-0008612, filed on Jan. 26, 2007, in the Korean Intellectual Property Office, the disclosure of which is incorporated herein in its entirety by reference.

### BACKGROUND OF THE INVENTION

1. Technical Field

The present invention relates to flash memory, and more particularly, to an apparatus for and method of controlling an embedded NAND flash memory.

2. Discussion of the Related Art

Flash memory is a non-volatile memory device that retains its data after power is turned off. Flash memory is mainly used to store a large amount of information for portable devices such as digital cameras, MP3 players, cellular phones, universal serial bus (USB) drives, and the like. Flash memory can be NAND flash memory of a data storage type or a NOR flash memory of a code storage type.

In NAND flash memory, a large number of storage units called “cells” are arranged vertically. The cells can be formed in a small area, thereby allowing for storage of voluminous data. In NOR flash memory, the cells are arranged horizontally, and only a relatively small amount of data can be stored. However, NOR flash memory has a relatively high reading speed. For this reason, NOR flash memory is used to store core data of a high-speed device such as a cellular phone. NOR flash memory has an independent address space and a separate address bus and data bus, and thus can be easily interfaced by a central processing unit (CPU). However, NAND flash memory has a bus that functions as both an address bus and a data bus and has no independent address space. NAND flash memory thus requires hardware control logic.

As a result, the operation of NAND flash memory is generally controlled according to a predetermined algorithm hard-wired into a chip.

However, such a configuration does not easily optimize programming/erase and read operations. Since the algorithm for controlling the operation of the NAND flash memory is hard-wired, it may not easily adapt to a sudden change in an external environment, and accordingly, the chip may malfunction.

### SUMMARY OF THE INVENTION

Exemplary embodiments of the present invention provide an apparatus for and method of controlling an embedded NAND flash memory using an internal code.

Exemplary embodiments of the present invention provide a computer-readable recording medium having recorded thereon a program for implementing the method.

According to one aspect of the present invention, there is provided an apparatus for controlling an embedded NAND flash memory. The apparatus includes a code memory storing code information used for controlling an access to a NAND flash memory. A register stores code information corresponding to a command to be executed by the NAND flash memory. A central processing unit (CPU) reads the code information, corresponding to the command to be executed by the NAND flash memory, from the code memory and stores the read code information in the register. A hard-wired logic circuit performs the NAND flash memory access according to the code information stored in the register.

The code information may include information for setting a parameter of the NAND flash memory, and the parameter may include write and read bias voltage factors.

The NAND flash memory may be accessed by the code information stored in the code memory.

The CPU may perform a control operation such that the NAND flash memory is accessed using an internally generated clock signal.

The register may be a special function register.

The hard-wired logic circuit may include a logic circuit for performing a programming unit function and a verification unit function.

According to an aspect of the present invention, a method of controlling an embedded NAND flash memory is provided. The method includes determining whether an access command associated with an access to a NAND flash memory is an input command. If the access command is an input command, code information corresponding to the input access command is read from a code memory that stores code information for controlling the NAND flash memory, the read code information is stored in a register, and the NAND flash memory access is performed according to the stored code information.

The execution of a programming process and a verification process may be controlled according to the code information during a write operation. The programming process and the verification process may be repeated while changing the parameter if the verification process fails.

According to an aspect of the present invention, a computer-readable recording medium, having a program for implementing the method recorded thereon, is provided.

### BRIEF DESCRIPTION OF THE DRAWINGS

The above and other features and aspects of the present invention will become more apparent by describing in detail exemplary embodiments thereof with reference to the attached drawings in which:

FIG. 1 is a block diagram of an apparatus for controlling an embedded NAND flash memory according to an exemplary embodiment of the present invention;

FIG. 2 illustrates the internal structure of the NAND flash memory according to an exemplary embodiment of the present invention;

FIG. 3 illustrates a process for performing a programming operation in the embedded NAND flash memory according to an exemplary embodiment of the present invention;

FIG. 4 is a flowchart of a method for controlling an embedded NAND flash memory according to an exemplary embodiment of the present invention; and

FIG. 5 is a flowchart of a process for executing a write command using a NAND flash driving code (e-code) according to an exemplary embodiment of the present invention.

### DETAILED DESCRIPTION OF EXEMPLARY EMBODIMENTS

Exemplary embodiments of the present invention are described in detail below with reference to the accompanying drawings. Like reference numerals may refer to like elements throughout.

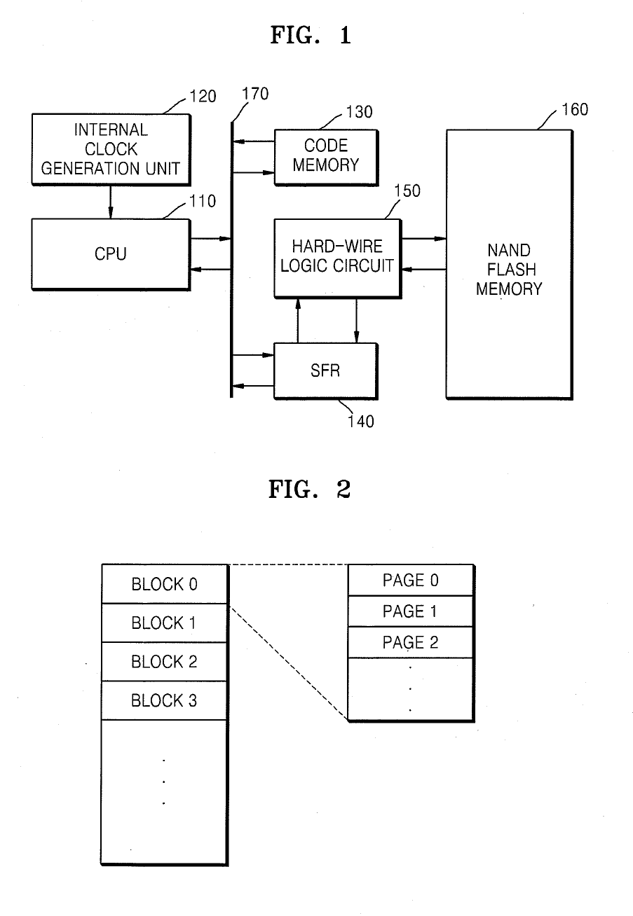

FIG. 1 is a block diagram of an apparatus for controlling an embedded NAND flash memory 160 according to an exemplary embodiment of the present invention.

Referring to FIG. 1, the apparatus includes a central processing unit (CPU) 110, an internal clock generation unit 120, a code memory 130, a special function register (SFR) 140, a hard-wired logic circuit 150, the NAND flash memory 160, and an internal bus line 170.

A program and a logic circuit for accessing the NAND flash memory 160 are integrated, together with the NAND flash memory 160, in a single chip.

The NAND flash memory 160 includes a plurality of blocks as illustrated in FIG. 2. Each of the blocks includes a plurality of pages. Erase operations are performed in units of blocks and read/write operations are performed in units of pages.

A basic unit for data storage in the NAND flash memory 160 is a cell and each cell stores 1-bit of information represented by a “1” or a “0.”

The erase operation with respect to the NAND flash memory 160 is performed by changing values of all cells included in a designated block into “1.” For example, for the erase operation with respect to the NAND flash memory 160, “0” stored in a cell is changed to “1” and “1” stored in a cell is maintained.

The write operation with respect to the NAND flash memory 160 varies with a value stored in a cell and a value to be written in the cell. For example, if “1” has been stored in a cell, for example, the cell has been erased, the write operation with respect to the cell is performed irrespective of whether a value to be written in the cell is “0” or “1.” If “0” has been stored in a cell, a value is not written in the cell.

Thus, after data has been written to a page of cells, an erase operation is performed on the block of cells that includes the page before data may again be written to the page of cells.

The internal clock generation unit 120 divides an oscillation signal generated by an oscillation device (not shown) to generate a clock signal having a frequency desired by a system. In exemplary embodiments of the present invention, an access to the NAND flash memory 160, for example, a NAND flash memory access, is implemented using an internal clock signal generated by the internal clock signal generation unit 120.

Code information, e.g., e-codes, for controlling the NAND flash memory access 160, are stored in the code memory 130. The code memory 130 may be non-volatile memory. Thus, the operation of the NAND flash memory 160 is controlled by the code information stored in the code memory 130.

Code information for setting parameters of the NAND flash memory 160 is also stored in the code memory 130. The parameters may be write and read bias voltage factors. However, other factors that determine the performance of the NAND flash memory 160 may also be among the parameters set according to the code information stored in the code memory 130.

For example, the code information may control the execution of a programming process and a verification process according to a write command. For example, the code information may control the programming process and the verification process to be repeated while changing a parameter associated with the performance of the programming process and the verification process if verification fails during the verification process.

The parameter associated with the performance of the programming process and the verification process may be, for example, write and read bias voltage factors.

The SFR 140 is a register used for a special function, such as storing codes required for controlling the operation of the NAND flash memory 160. The SFR 140 may include, for example, a state register representing a state of the CPU 110 after the execution of an arithmetic operation, a logic operation or other commands, an option register for performing setting associated with a timer/counter, an interrupt register for controlling an interrupt process, a register for designating an address, and/or an input/output register.

The hard-wired logic circuit 150 performs a unit function and includes logic circuits for performing a programming unit function and a verification unit function according to the code information stored in the SFR 140.

The CPU 110 performs a control operation such that the NAND flash memory access is made using the internal clock signal generated by the internal clock generation unit 120.

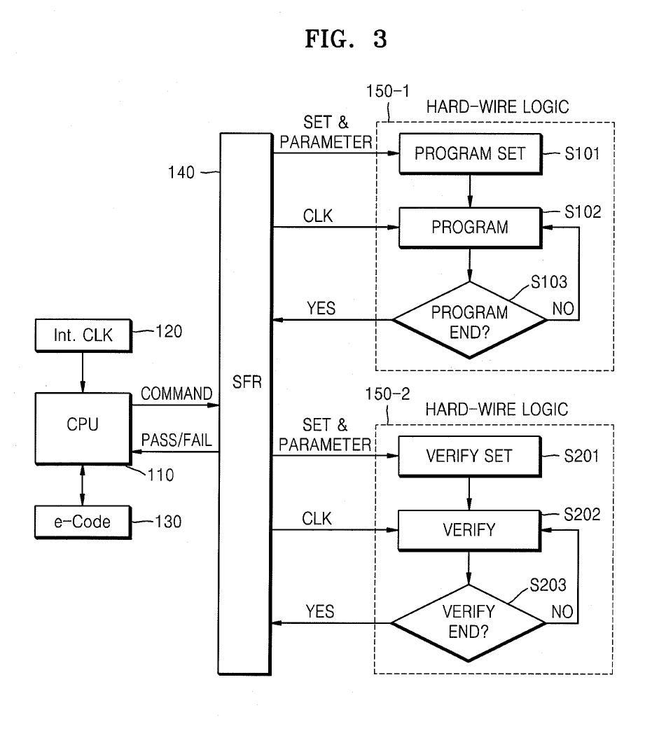

The operation of the apparatus for controlling an embedded NAND flash memory illustrated in FIG. 1 will is described below with reference to FIG. 3.

FIG. 3 illustrates a process for performing a programming operation in the embedded NAND flash memory according to an exemplary embodiment of the present invention.

Upon receipt of a command from a host device (not shown), the CPU 110 determines whether the received command is an access command associated with the NAND flash memory access.

If the received command is the access command, the CPU 110 performs a control operation such that the NAND flash memory 160 is accessed using an internal clock signal generated by the internal clock generation unit 120.

The CPU 110 reads code information corresponding to the received command from the code memory 130 and stores the read code information in the SFR 140. The code information stored in the SFR 140 includes parameter setting information for setting a parameter of the NAND flash memory 160.

After a hard-wared logic circuit 150-1 sets parameters for performing a programming process according to the parameter setting information stored in the SFR 140 in operation S101, the logic circuit 150-1 performs the programming process using the internal clock signal generated by the internal clock generation unit 120 in operation S102.

Once the programming process is completed (yes, operation S103), the hard-wired logic circuit 150-1 transmits a signal indicating the completion of the programming process to the CPU 110 through the SFR 140. The CPU 110 then reads code information for performing a verification process from the code memory 130 and stores the read code information in the SFR 140. If the programming process is not completed successfully (no, operation S103), then the programming is repeated (operation S102).

A hard-wired logic circuit 150-2 sets parameters for performing the verification process according to the parameter setting information stored in the SFR 140 in operation S201. The hard-wired logic circuit 150-2 then performs the verification process using the internal clock signal generated by the internal clock generation unit 120 in operation S202.

Once the verification process is completed (yes, operation S203), the hard-wired logic circuit 150-2 transmits a signal indicating a verification result to the CPU 110 through the SFR 140. If the verification process is not completed successfully (no, operation S203), then the verification is repeated (operation S202).

As such, the NAND flash memory access can be made using code information stored in the code memory 130. Thus, a basic operation of the NAND flash memory 160 is implemented by the hard-wired logic circuit 150 and an the NAND flash memory access is implemented by a control over the hard-wired logic circuit 150 using code information stored in the code memory 130.

By performing the NAND flash memory access using the internal clock signal instead of an external clock signal input from outside, a data processing speed can be increased.

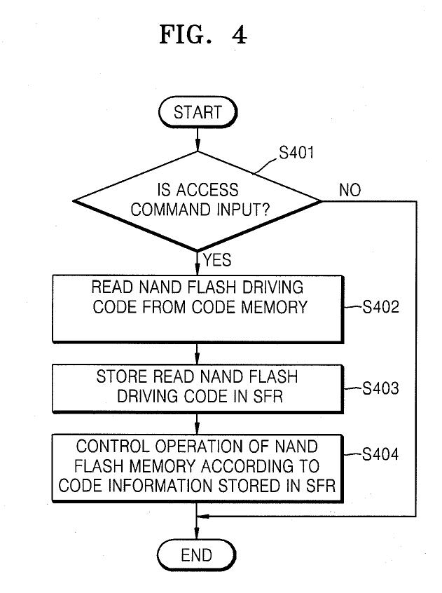

A method for controlling an embedded NAND flash memory according to an exemplary embodiment of the present invention is described below with reference to FIG. 4.

It is determined whether an access command associated with the NAND flash memory access is input to the CPU 110 in operation S401.

If the access command is input (yes, operation 401), the CPU 110 reads NAND flash driving codes (e-codes) for implementing the input command from the code memory 130 in operation S402.

The CPU 110 stores the read NAND flash driving codes in the SFR 140 in operation S403.

The CPU 110 controls setting of parameters of the NAND flash memory 160 and a detailed operation for the NAND flash memory access according to the NAND flash driving codes (code information) stored in the SFR 140 in operation S404.

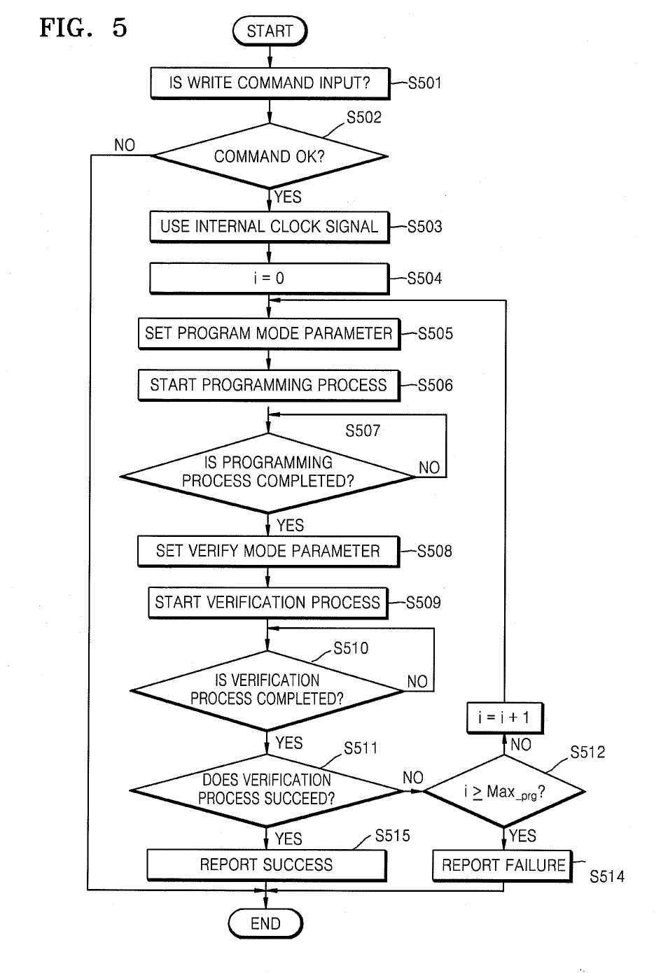

A method for executing a write command out of the access command using the NAND flash driving codes (e-codes) is described below with reference to FIG. 5.

To execute a write mode with respect to the NAND flash memory 160, the write command is input to the CPU 110 in operation S501.

The CPU 110 then determines whether an executable command is input normally in operation S502.

If the write command is input normally (yes, operation S502), an internal clock signal is applied to data processing in operation S503, thereby increasing a data processing speed.

Next, the following operation is performed according to code information that has been read from the code memory 130 and then stored in the SFR 140 to perform a programming process in response to the write command.

First, an internal counter (not shown) of the CPU 110 resets a counter “i” to 0 in operation S504.

Next, a program mode parameter Pi_prg associated with the performance of a program mode is set according to the code information stored in the SFR 140 in response to the counter value i in operation S505. For example, the program mode parameter Pi_prg may be a factor that determines a write bias voltage.

The programming process is performed according to the code information stored in the SFR 140 in operation S506. The programming process is performed by the hard-wired logic circuit 150 according to the code information stored in the SFR 140.

In operation S507, it is determined whether the programming process is completed based on flag information indicating whether or not the programming process is completed in the hard-wired logic circuit 150.

If the programming process is completed (yes, operation S507), the following operation is performed according to the code information that has been read from the code memory 130 and then stored in the SFR 140 to perform a verification process. If the programming process is not completed (no, operation S507), programming resumes until the programming process is completed.

A verify mode parameter Pi_ver associated with the performance of a verify mode is set according to the code information stored in the SFR 140 in response to the counter value i in operation S508. For example, the verify mode parameter Pi_ver may be a factor that determines a read bias voltage.

The verification process is performed according to the code information stored in the SFR 140 in operation S509. The verification process is performed by the hard-wired logic circuit 150 according to the code information stored in the SFR 140.

It is determined whether the verification process is completed in operation S510 based on flag information indicating whether or not the verification process is completed in the hard-wired logic circuit 150.

If the verification process is completed (yes, operation S510), it is determined whether the programming process is performed normally to determine whether the verification process succeeds in operation S511. For example, data written in the NAND flash memory 160 during the programming operation is read and then compared with data stored in a buffer (not shown) after being written during the programming operation. If they match with each other, it is determined that the verification process succeeds. Otherwise, it is determined that the verification process fails.

If the verification process fails (no, operation S511), it is determined whether the counter value i is greater than or equal to a maximum program repeat number Max_prg in operation S512.

If the counter value i is smaller than the maximum program repeat number Max_prg (no, operation S512), the counter value i is increased by 1 and then fed back to operation S505.

As the counter value i is increased, the program mode parameter Pi_prg and the verify mode parameter Pi_ver are changed and the program mode and the verify mode are performed using the modified program mode parameter Pi_prg and verify mode parameter Pi_ver.

If the counter value i is greater than or equal to the maximum program repeat number Max_prg (yes, operation S512), a signal indicating that the verification process fails is transmitted to the CPU 110 in operation S514.

If the verification process succeeds (yes, operation S511), a signal indicating that the verification process succeeds is transmitted to the CPU 110 in operation S515.

Accordingly, the NAND flash memory access can be performed using code information stored in the code memory 130.

As described above, according to exemplary embodiments of the present invention, the NAND flash memory access is performed using internal codes stored in a code memory, thereby simplifying the configuration of a hard-wired logic circuit and thus reducing a chip size. Moreover, the overall control process can be easily changed by code modification and parameters associated with the operation of the NAND flash memory can be easily changed.

Exemplary embodiments of the present invention may be implemented as a method, a device, and/or a system. When exemplary embodiments of the present invention are implemented as software, elements of the present invention may be code segments for performing an operation. Program or code segments may be stored in a processor-readable medium or may be transmitted through a computer data signal combined with carrier waves in a transmission medium or a communication network. The processor-readable medium is any medium capable of storing or transmitting information. Examples of processor-readable recording media include electric circuits, semiconductor memory devices, read-only memory (ROM), flash memory, Erasable ROM(EROM), floppy disks, optical data storage devices, hard disks, optical fiber media, and radio frequency (RF) networks. A computer data signal may be any signal that can be transmitted over a transmission medium such as an electric network channel, an optical fiber, air, an electromagnetic field, and/or an RF network.

While exemplary embodiments of the present invention have been particularly shown and described with reference to the figures, various changes in form and detail may be made therein without departing from the spirit and scope of the present invention.

What is claimed is:

1. An apparatus for controlling an embedded NAND flash memory, the apparatus comprising:
a code memory storing code information for controlling access to a NAND flash memory;
a register storing code information corresponding to a command to be executed by the NAND flash memory;
a central processing unit (CPU) reading the code information, corresponding to the command to be executed by the NAND flash memory, from the code memory and storing the read code information in the register; and
a hard-wired logic circuit performing the NAND flash memory access according to the code information stored in the register.

2. The apparatus of claim 1, wherein the code memory is non-volatile memory.

3. The apparatus of claim 1, wherein the code information includes information for setting a parameter of the NAND flash memory.

4. The apparatus of claim 3, wherein the parameter includes write and read bias voltage factors.

5. The apparatus of claim 1, wherein the NAND flash memory is accessed according to the code information stored in the code memory.

6. The apparatus of claim 1, wherein the CPU performs a control operation such that the NAND flash memory is accessed using an internally generated clock signal.

7. The apparatus of claim 1, wherein the register is a special function register.

8. The apparatus of claim 1, wherein the hard-wired logic circuit is configured to perform one or more unit functions.

9. The apparatus of claim 1, wherein the hard-wired logic circuit includes a logic circuit for performing a programming unit function and a verification unit function.

10. A method of controlling an embedded NAND flash memory, the method comprising:
determining whether an access command associated with an access to a NAND flash memory is input;
reading code information corresponding to the input access command from a code memory storing code information for controlling the NAND flash memory, when it is determined that the access command is input;
storing the read code information in a register; and
performing the NAND flash memory access according to the stored code information.

11. The method of claim 10, wherein the code information includes information for setting a parameter of the NAND flash memory.

12. The method of claim 10, wherein the parameter includes write and read bias voltage factors.

13. The method of claim 10, wherein the NAND flash memory is accessed according to the code information stored in the code memory.

14. The method of claim 10, wherein the register is a special function register.

15. The method of claim 10, wherein, during a write operation, execution of a programming process and a verification process are controlled according to the code information, and the programming process and the verification process are repeated while changing a parameter of the NAND flash memory when the verification process fails.

16. The method of claim 15, wherein the parameter includes write and read bias voltage factors.

17. The method of claim 10, wherein an internal system clock signal is used when the NAND flash memory access is performed.

18. A computer-readable recording medium having recorded thereon a program for implementing a method for controlling an embedded NAND flash memory, the method comprising:
determining whether an access command associated with an access to a NAND flash memory is input;
reading code information corresponding to the input access command from a code memory storing code information for controlling the NAND flash memory, when it is determined that the access command is input;
storing the read code information in a register; and
performing the NAND flash memory access according to the stored code information.

19. The recording medium of claim 18, wherein the code information includes information for setting a parameter of the NAND flash memory.

20. The recording medium of claim 18, wherein the NAND flash memory is accessed according to the code information stored in the code memory.

21. The recording medium of claim 18, wherein during a write operation, execution of a programming process and a verification process are controlled according to the code information, and the programming process and the verification process are repeated while changing a parameter of the NAND flash memory when the verification process fails.
